(19) United States
(12) Patent Application Publication
(10) Pub. No.: US 2008/0075094 A1
(43) Pub. Date: Mar. 27, 2008

(54) METHOD AND APPARATUS FOR USING AND RELAYING FRAMES OVER MOBILE MULTI-HOP RELAY SYSTEMS

(75) Inventors: Dong Hyun AHN, Daejeon-city (KR); Choongil YEH, Daejeon-city (KR); Young-il KIM, Daejeon-city (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon-city (KR)

(21) Appl. No.: 11/860,711

(22) Filed: Sep. 25, 2007

(30) Foreign Application Priority Data
Sep. 26, 2006 (KR) 10-2006-0093648
Jul. 16, 2007 (KR) 10-2007-0071266

(51) Int. Cl. H04L 12/28

(52) U.S. Cl. 370/400

(57) ABSTRACT

Provided are a method and apparatus for using and relaying multi-hop frames over mobile multi-hop relay (MMR) systems. According to the present invention, a base station in a MMR network determines the number and temporal length of unit frames to be included in a super frame, allocates channel periods for transmitting data having a communication request to uplink and downlink data channels of each unit frame, generates frame control information to be the same for each unit frame and transmits each piece of the frame control information for each unit frame together with downlink data to be transmitted. A relay station according to the present invention recognizes frame control information of a received unit frame, reorganizes the frame control information of the received unit frame in order to allow a base station and neighboring relay stations to transmit the same frame control information from a subsequent unit frame, transmits the reorganized frame control information through the subsequent unit frame to the neighboring relay stations, thereby preventing interference between the base station and the relay stations and waste of channels of the unit frame which is caused by retransmitting the frame control information.

### CROSS-REFERENCE TO RELATED PATENT APPLICATION

This application claims the benefit of Korean Patent Application No. 10-2006-0093648, filed on Sep. 26, 2006 and Korean Patent Application No. 10-2007-0071266, filed on Jul. 16, 2007, in the Korean Intellectual Property Office, the disclosure of which is incorporated herein in its entirety by reference.

### BACKGROUND OF THE INVENTION

1. Field of the Invention

The present invention relates to a method and apparatus for using and relaying frames over a mobile multi-hop relay (MMR) network, and more particularly, to a method of controlling an MMR network for expanding a communication region between a base station and a plurality of mobile stations and improving communication performance in an inferior radio propagation environment by adopting a relay station which receives wireless data from a typical wireless data access network formed between the base station and the mobile stations and relays the wireless data to neighboring regions.

The present invention is derived from research conducted as a part of “IT New Growing Engine Core Technology Development Projects” promoted by the Ministry of Information and Communication, Republic of Korea. [Project No.: 2006-S-011-01, Project Title Relay/Mesh Communication System Development for Multi-hop WiBro]

2. Description of the Related Art

Despite development of wireless network services, if mobile stations are not included in a direct communication region of a base station or the mobile stations included in the direct communication region are in inferior communication environments, data communication between the base station and the mobile stations cannot be performed properly.

In order to reduce communication-impossible regions in a service region of the base station, improve communication quality between mobile stations and the base station, or expand the service region of the base station, relay stations are currently employed to receive, regenerate and retransmit downlink data signals transmitted from the base station to the mobile stations and uplink data signals transmitted from the mobile station to the base station. These relay stations are used in a mobile multi-hop relay (MMR) network that is regarded as new technology in wireless data communications.

Here, the base station and the relay stations are disposed at different positions from each other so that, although the base station and the relay stations transmit the same signals at the same point of time, the signals may arrive at a destination at different points of time. In this case, information included in the signals may not be easily restored by using a conventional wireless signal modulation/demodulation method. However, by using a new wireless signal modulation/demodulation method such as an orthogonal frequency division multiplexing (OFDM) method, the signals are recognized and processed as delayed replicas and thus the signals can be received and processed without problem.

Conventionally, in order to provide communication services of the base station to the mobile stations in inferior communication environments such as underground regions, tunnels, and buildings in a single frequency network, an analog repeater (AR), or an interference cancellation system (ICS) that reduces noise caused by reverse flow of signals while amplifying and transmitting analog signals at the same time, have been used. However, although the AR and ICS receive, amplify, and retransmit analog signals, the AR and ICS may not process external interference. Therefore, the AR and ICS may be advantageously used in the ground regions or tunnels close to the base station. However, if two or more ARs and ICSs are used in order to expand the communication region of the base station for providing communication services to regions comparatively far from the base station, original signals may not be maintained due to external interference, the signals may not be easily restored due to long temporal delay, and improvement of system performance for maintaining or improving signal quality is difficult.

The Institute of Electrical and Electronics Engineers (IEEE) 802.16 Task Group j (TGj) as of September, 2006, began to standardize systems adopting a concept of the MMR network and several suggestions were made. For example, the suggestions include a method of adopting an additional frequency channel between the base station and the relay stations so as to transmit data through the frequency channel (IEEE C802.16j-06/001; 01 May 2006, IEEE C802.16j-06/029; May 2006, and IEEE C802.16j-06/008; May 2006), and a method of directly transmitting frame control data of a wireless frame signal by the base station instead of the relay stations or transmitting the frame control data by using analog transmission technology, and a method of dividing a unit frame into a region for the base station, a region for the relay stations, and a region for the mobile stations (IEEE C802.16 mmr-05/023; November 2005, IEEE 802.16j-06/004; May 2006).

However, the above suggestions have problems as described below.

First, when all or a part of the analog signal is amplified, externally received noise is also amplified. Thus, although the reception power of the signal is getting higher as the signal is relayed more frequently, the signal to noise ratio is reduced. Second, additional wireless frequency resources have to be used for relaying the signal. Third, overheads increase as channel resources to be used for one-hop communication directly between node links (a base station-a mobile station, a base station-a relay station, a relay station-a relay station, and a relay station-a mobile station) are allocated to each link by temporally dividing a unit frame. Fourth, the maximum number of relaying hops is restricted to two or three.

That is, by using the method of adopting the additional frequency channel, the frequency resources may not be efficiently used and the MMR network becomes more complex. By using the method of directly transmitting a part of the signal by the base station or by using the analog transmission technology, the distance of relaying hops is restricted and the interference increases so that the method can only be partially used for a short relay distance. Also, if frame control information and uplink/downlink data are temporally transmitted through the unit frame as repeatedly as the number of hops of the relay stations, the overheads increase so that communication performance is deteriorated.

### SUMMARY OF THE INVENTION

The present invention provides a method and apparatus for using and relaying multi-hop frames over mobile multi-hop relay (MMR) systems in which: the distance of relaying hops is not restricted while the relaying hops use a single frequency channel; interference between a base station, relay stations, and mobile stations is fundamentally prevented from occurring; and performance deterioration caused by expanding frame control information is reduced. According to the present invention, MMR cells may be flexibly designed in an MMR network, operation of the MMR network is not restricted by the maximum number of hops (or the maximum number of relaying) and the frame control information is not retransmitted in a unit frame, thereby preventing waste of channels of the unit frame. Furthermore, additional wireless frequency resources are not necessary for relaying a signal and overheads caused by restriction of temporal positions of uplink and downlink data channels may be reduced due to topology of an MMR system.

According to an aspect of the present invention, there is provided a method of generating and transmitting a super frame to be used as a communication frame by a base station in a mobile multi-hop relay network, the method including (a) determining the number and temporal length of unit frames which are basic units for data communication and are to be included in the super frame formed by binding one or more sequential unit frames on a time axis; (b) allocating channel periods for transmitting data having a communication request to uplink and downlink data channels of each unit frame based on topology and communication requests of the mobile multi-hop relay network; (c) generating frame control information which includes common reference information for recognizing and analyzing the unit frames, to be the same for each unit frame and allocating each piece of the frame control information to each unit frame included in the super frame; and (d) transmitting each piece of the frame control information for each unit frame included in the super frame together with downlink data to be transmitted, based on the allocated channel periods.

According to another aspect of the present invention, there is provided a method of managing routing information of a relay station for relaying data between a base station and a mobile station in a mobile multi-hop relay network, the method including (a) if the relay station recognizes that a new mobile station approaches the mobile multi-hop relay network through a relay station report channel which is an uplink report channel to the base station or a random access channel for transmitting information of mobile stations to the base station, adding a link address of the new mobile station to the routing information of the relay station; and (b) if the relay station determines not to manage a link address checked through a relay station control information channel from the base station, or, if uplink or downlink data transmission is not performed for a predetermined period of time through a link address managed by the relay station, removing the link address from the routing information of the relay station.

According to another aspect of the present invention, there is provided a method of generating and transferring relay station control information for controlling operations of a relay station by a base station in a mobile multi-hop relay network, the method including (a) generating the relay station control information including at least two of frame identifier information of an initial unit frame of a super frame which is to be used as a communication frame and is formed by binding one or more sequential unit frames on a time axis which are basic units for data communication, frame identifier information of a final unit frame of the super frame, and length information of the super frame; and (b) transferring the relay station control information to a target relay station by allocating the relay station control information to a downlink data channel of a unit frame or including the relay station control information to frame control information of the unit frame.

According to another aspect of the present invention, there is provided a relay station for processing unit frames in a mobile multi-hop relay network, the relay station including a frame control information reorganization unit recognizing frame control information of a received unit frame and reorganizing the frame control information of the received unit frame into frame control information of a predetermined or predicted subsequent unit frame in order to allow a base station and neighboring relay stations to transmit the same frame control information through the subsequent unit frame; a frame control information transmission unit transmitting the reorganized frame control information through the subsequent unit frame to the neighboring relay stations; a downlink data channel processing unit transmitting data through the subsequent unit frame if the data exists in a downlink data channel of the received unit frame which passes through the relay station; and an uplink data channel processing unit transmitting data through the subsequent unit frame if the data exists in an uplink data channel or a random access channel of the received unit frame which passes through the relay station.

According to another aspect of the present invention, there is provided a method of processing unit frames by a relay station in a mobile multi-hop relay network, the method including (a) recognizing frame control information of a received unit frame and reorganizing the frame control information of the received unit frame into frame control information of a predetermined or predicted subsequent unit frame in order to enable a base station and neighboring relay stations to transmit the same frame control information through the subsequent unit frame; (b) transmitting the reorganized frame control information through the subsequent unit frame to the neighboring relay stations; (c) transmitting data through the subsequent unit frame if the data exists in a downlink data channel of the received unit frame which passes through the relay station; and (d) transmitting data through the subsequent unit frame if the data exists in an uplink data channel or a random access channel of the received unit frame which passes through the relay station.

According to another aspect of the present invention, there is provided a computer readable recording medium having recorded thereon a unit frame to be used in data communication between a base station and a mobile station in a mobile multi-hop relay network, the unit frame including a downlink data channel period for data transmission from the base station to the mobile station; an uplink data channel period for data transmission from the mobile station to the base station with permission of the base station; and a frame control information channel period for transmitting frame control information which is common reference information for recognizing and analyzing the unit frame of transmitted data and prevents communication interference between the base station and a relay station by maintaining the frame control information to be the same except for frame identifier information of the unit frame as frame control information of other unit frames included in a super frame which includes the unit frame.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram for illustrating a structure of a mobile multi-hop relay (MMR) network, according to an embodiment of the present invention;

FIG. 2 is a diagram for illustrating structural correlations between unit frames and super frames (multi frames), according to an embodiment of the present invention;

FIG. 3 is a diagram for illustrating a structure of a unit frame including frame control information, according to an embodiment of the present invention;

FIG. 4 is a diagram for illustrating an internal structure of a unit frame such as the unit frame illustrated in FIG. 3, according to an embodiment of the present invention;

FIG. 5 is a diagram for illustrating communication requests and topology of a network at a point of time when a super frame begins to be generated, according to an embodiment of the present invention;

FIG. 6 is a flowchart of a method of generating and transmitting a super frame by a base station in an MMR network, according to an embodiment of the present invention.

FIG. 7 is a detailed flowchart of a method of using frames in an MMR network, the method including the method of FIG. 6, according to an embodiment of the present invention;

FIG. 8 is a table for illustrating the result of allocating hop channels for a super frame by using the method of FIG. 7 if topology and communication requests of a MMR network are assumed to be as illustrated in FIG. 5, according to an embodiment of the present invention;

FIG. 9 is a diagram for illustrating communication channels required for managing routing information that has to be maintained for processing unit frames by a relay station, according to an embodiment of the present invention;

FIG. 10 is a flowchart of a method of managing routing information by a relay station, according to an embodiment of the present invention;

FIG. 11 is a flowchart of a method of generating and transferring relay station control information by a base station, according to an embodiment of the present invention;

FIG. 12 is a block diagram of a relay station for processing unit frames, according to an embodiment of the present invention;

FIG. 13 is a flowchart of a method of processing unit frames and transmitting frame control information and data by a relay station, according to an embodiment of the present invention;

FIG. 14 is a detailed flowchart of the method of FIG. 13, according to an embodiment of the present invention;

FIG. 15 is a detailed diagram of a method of processing and transmitting downlink data in operation 1303 of FIG. 13, according to an embodiment of the present invention;

FIG. 16 is a detailed diagram of a method of processing and transmitting uplink data in operation 1304 of FIG. 13, according to an embodiment of the present invention;

FIG. 17 is a table for illustrating output signals of a base station, relay stations, and mobile stations after processing unit frames and transmitting data in accordance with the method of FIG. 13 from the result of allocating hop channels which is illustrated in FIG. 8 in a MMR network, according to an embodiment of the present invention.

### DETAILED DESCRIPTION OF THE INVENTION

Hereinafter, the present invention will be described in detail by explaining embodiments of the invention with reference to the attached drawings. In the following description of the present invention, a detailed description of known functions and configurations incorporated herein will be omitted when it may make the subject matter of the present invention unclear.

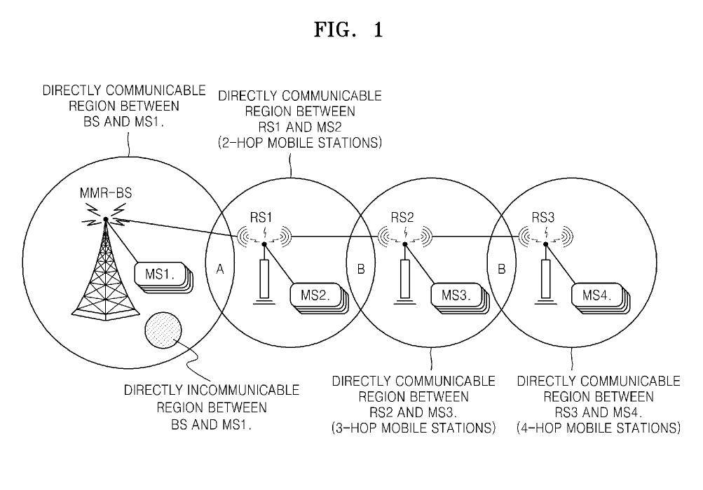

FIG. 1 is a diagram for illustrating a structure of a mobile multi-hop relay (MMR) network, according to an embodiment of the present invention.

In a wireless access network in which data communication is enabled between a base station and neighboring mobile stations through communication medium and communication means, a service region of the base station is expanded and a high-quality signal is transmitted to a destination by adapting at least one relay station, which improves a received signal and transmits the high-quality signal, between the base station and the mobile stations.

Referring to FIG. 1, mobile stations MS1. in a circular direct communication region of a one-hop distance from a base station MMR-BS may directly communicate with the base station MMR-BS and thus may be connected to the base station MMR-BS without being relayed. However, mobile stations MS2., MS3., and MS4. out of the direct communication region may not be connected to the base station MMR-BS without being relayed. Furthermore, in a shaded region which is included in the direct communication region but is an inferior communication environment, communication between the base station MMR-BS and the mobile stations MS2., MS3., and MS4. is not efficiently performed.

Thus, relay stations RS1, RS2, and RS3 support the mobile stations MS2., MS3., and MS4. so as to efficiently communicate with the base station MMR-BS and thus the performance of the MMR network is improved.

The present invention suggests a method and apparatus for using and processing multi-hop frames in a MMR network.

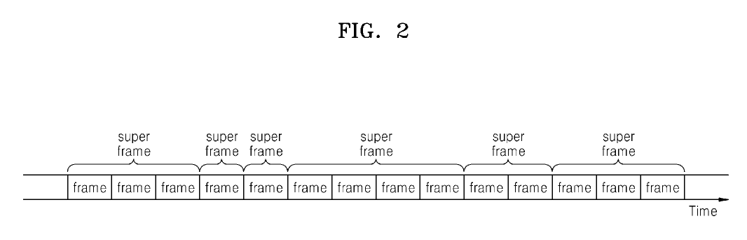

FIG. 2 is a diagram for illustrating structural correlations between unit frames and super frames (multi frames), according to an embodiment of the present invention.

A base station generates a data frame on the time axis of a wireless channel for wireless data communication. One or more sequential frames on the time axis are combined and the combination is referred to as a super frame or a multi frame and each frame included in the super frame is referred to as a unit frame. Unit frames included in one super frame have to have the same temporal length. In order to explain the present invention more clearly, terms used to describe embodiments of the present invention are defined as below.

The unit frame (or a frame) is a basic period of time required for data communication in a communication system. In the unit frame, data and information required to decode the data are coded by a predetermined protocol.

A unit frame identifier such as a frame recognizer identifies a corresponding unit frame so as to be distinguished or recognized by a data receiver. In particular, unit frame identifiers are used in order to identify neighboring unit frames.

Frame control information is partial information of the unit frame and is commonly referred by entire receivers in order to recognize or analyze the unit frame. A mobile station may correctly transmit or receive information on the mobile station by using the frame control information. An example of the frame control information is a frame header.

The super frame is a set of one or more temporally subsequent unit frames. The length of the super frame is the same as the total number of unit frames included in the super frame.

Lastly, a node is an object that transmits or receives a signal in a communication network. Examples of the node are a base station, a relay station, and a mobile station.

In the present invention, a method of using frames relates to the length of a super frame, that is, the number of unit frames to be included in the super frame in accordance with communication requests of mobile stations and network topology which represents the arrangement of the mobile stations at a point of time when the super frame begins to be generated for multi-hop relaying, a method of allocating channels in each unit frame, and a method of transferring usage information of the super frame to a relay station and operating the relay station. Accordingly, the length of the super frame may vary in accordance with the topology of a MMR network at the point of time when the super frame begins to be generated. The base station may update information for maintaining the network topology whenever a frame is completely transmitted using information received through an uplink random access channel and a relay station report channel, that is, an uplink data channel.

A relay signal is processed with regard to a method of transmitting/receiving a frame by using information previously determined between the relay station and the base station or by using usage information of the super frame which is included in each unit frame or information on other mobile stations and relay stations which are connected to the base station and passed through the relay station.

In the MMR network, if necessary, the number of the unit frames (n, n>0) to be included in the super frame, the temporal length of each unit frame, and a period of the super frame are newly determined, frame control information except for information for identifying the unit frames such as unit frame identifiers is generated to be the same for the n unit frames included in the super frame, uplink and downlink data blocks are allocated in consideration of temporal order of the unit frames so as not to be contrary to the frame control information and are applied to the unit frames, and the frame identifiers are corrected in accordance with the temporal order and is applied to the unit frames. Hereby, the super frame is generated. According to an embodiment of the present invention, frame numbers may be used as the frame identifiers.

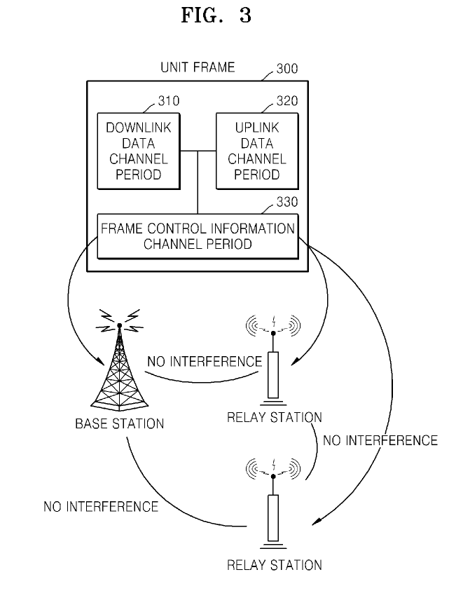

FIG. 3 is a diagram for illustrating a structure of a unit frame 300 including frame control information, according to an embodiment of the present invention.

Recently, as wireless communication technology develops, demands for related wireless devices and reliable high-speed data transmission through wireless links has grown. In response to the demands, a wireless local area network (WLAN) has been developed. In a WLAN system, mobile stations in a wireless service region transmit or receive data by using wireless resources allocated from a base station. In this case, the base station allocates the wireless resources in phase resources. The phase resources are periods in which the base station or the mobile stations are allowed to transmit data.

In a period of a transmission frame having a fixed length determined by the WLAN system, the base station firstly transmits mapping (MAP) frames so as to allocate the phase resources of the whole period of the transmission frame. A mobile station to which a period is allocated by the MAP frames receives or transmits data during a period indicated by corresponding downlink or uplink mobile station information.

As such, the base station estimates the amount of necessary resources for each mobile station in the period of the transmission frame and allocates periods of time for downlink and uplink in accordance with the estimated amount. On the other hand, if the base station under-estimates the amount of the necessary resources, the necessary resources can be allocated to the mobile station in a period of a subsequent transmission frame.

Referring to FIG. 3, the unit frame 300 is used as the transmission frame, and the period of time for downlink corresponds to a downlink data channel period 310 and the period of time for uplink corresponds to an uplink data channel period 320.

The unit frame 300 used for data communication between a base station and a mobile station includes the downlink data channel period 310 for transmitting data from the base station to the mobile station, the uplink data channel period 320 for transmitting data from the mobile station to the base station, and a frame control information channel period 330 for transmitting frame control information which is common reference information for recognizing and analyzing the unit frame 300 of transmitted data and maintaining the frame control information to be the same except for frame identifier information of the unit frame 300 prevents communication interference between the base station and a relay station. By maintaining the frame control information of the unit frame 300 to be the same for the base station and the relay station, communication interference between the base station and the relay station, or between the relay station and another relay station may be prevented.

However, how to maintain the frame control information to be the same between the base station and the relay station or how to transmit the frame control information will be described later.

The structure illustrated in FIG. 3 may be applied to the IEEE 802.16 standards.

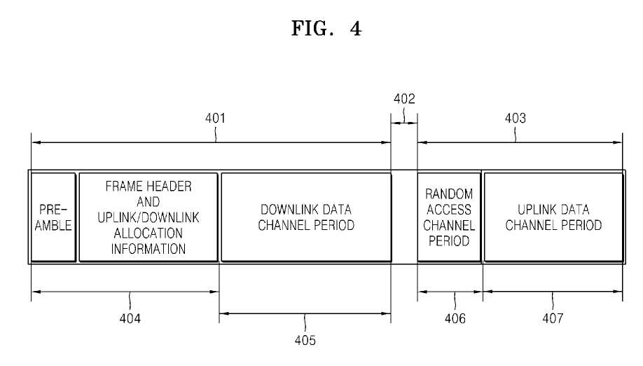

FIG. 4 is a diagram for illustrating an internal structure of a unit frame such as the unit frame 300 illustrated in FIG. 3, according to an embodiment of the present invention.

Referring to FIG. 4, a downlink channel period 401 for transmitting from a base station to a mobile station is included temporally early in the unit frame, an uplink channel period 403 for transmitting from the mobile station to the base station is included temporally late in the unit frame, and a channel protection period 402 required to convert reception/transmission modes is included between the downlink and uplink channel periods 401 and 403. The downlink channel period 401 is divided into a frame control information channel period 404 for transmitting frame control information, that is, partial information of the unit frame, to be commonly referred by all receivers of the unit frame for recognizing the unit frame, and for correctly receiving and analyzing the unit frame and a downlink data channel period or a downlink burst period 405 for transmitting message data to the receivers. The frame control information channel period 404 and the downlink data channel period 405 may temporally overlap.

The uplink channel period 403 is divided into a random access channel period or uplink access and control channels 406 for temporarily transmitting information on initial access of the mobile station and information generated from the mobile station to the basic station and an uplink data channel period or an uplink burst period 407 for transmitting message data from the mobile station to the base station with permission of the base station.

Also, a relay station control information channel period (not shown) including relay station control information for processing the unit frame by the relay station and a relay station report channel period (not shown) temporarily or regularly allocated for transmitting data reported from the relay station to the base station may be additionally included.

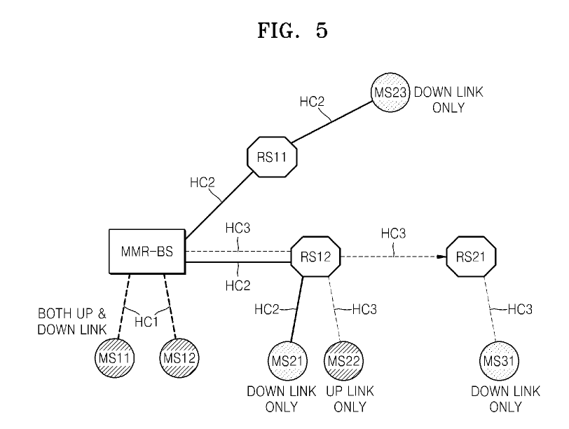

FIG. 5 is a diagram for illustrating communication requests and topology of a network at a point of time when generation of a super frame commences, according to an embodiment of the present invention.

Referring to FIG. 5, a reference numeral MMR-BS represents a base station, and reference numerals RSij and MSij represent a relay station and a mobile station which are successfully and completely registered by performing initial access with the base station, respectively. Here, i (i=1, 2, . . . ) represents the hop distance or the minimum number of hops (wireless links) which is required to connect a corresponding node to the base station, j represents an frame identifier for identifying relay stations or mobile stations having the same hop distance, and RS . . . and MS . . . represent all corresponding relay stations and mobile stations, respectively. For example, RSi and MSi represent all relay stations and mobile stations having an i-hop distance from the base station, respectively. A reference numeral HCh represents a hop channel allocated to a mobile station group which requires h (h=1, 2, . . . ) hops for data communication. For example, assuming that an uplink data channel is allocated in a new super frame with regard to a mobile station MS22, the hop channel to the mobile station MS22 is an uplink data channel HC3.

In particular, when mobile stations MS11 and MS12 having a one-hop distance request uplink and downlink data transmissions/receptions at the point of time when generation of the super frame commences, a downlink one-hop channel and an uplink one-hop channel are required. When mobile stations MS21 and MS23 having a two-hop distance request downlink data transmission, a downlink two-hop channel is required for each. When the mobile station MS22 having a two-hop distance requests uplink data transmission, an uplink three-hop channel is required. When a mobile station MS31 having a three-hop distance requests downlink data transmission, a downlink three-hop channel is required.

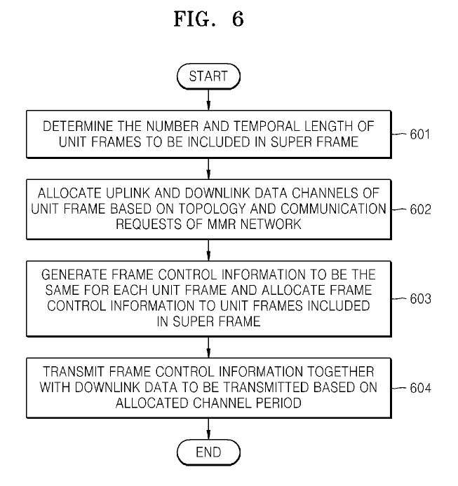

FIG. 6 is a flowchart of a method of generating and transmitting a super frame by a base station in an MMR network, according to an embodiment of the present invention.

Referring to FIG. 6, in operation 601, the number and temporal length of unit frames which are basic units used for data communication and are to be included in the super frame formed by binding one or more sequential unit frames on the time axis are determined.

In operation 602, channel periods for transmitting data having a communication request are allocated to uplink and downlink data channels of each unit frame based on topology and communication requests of the MMR network.

In operation 603, frame control information, that is, common reference information for recognizing and analyzing the unit frames, is generated to be the same for each unit frame and each piece of the frame control information is allocated to each of the unit frames included in the super frame.

In operation 604, each piece of the frame control information for each unit frame included in the super frame is transmitted together with downlink data to be transmitted, based on the allocated channel periods.

Particularly in operation 602, the channel periods are allocated by checking the number of hops which is the minimum number of wireless links between each mobile station and the base station, a data transmission request from each mobile station to the base station, and a data transmission request from the base station to each mobile station, determining hop channels for the data transmission requests in accordance with the number of hops based on the topology of the MMR network, and allocating the determined hop channels to uplink and downlink data channel periods of each unit frame included in the super frame.

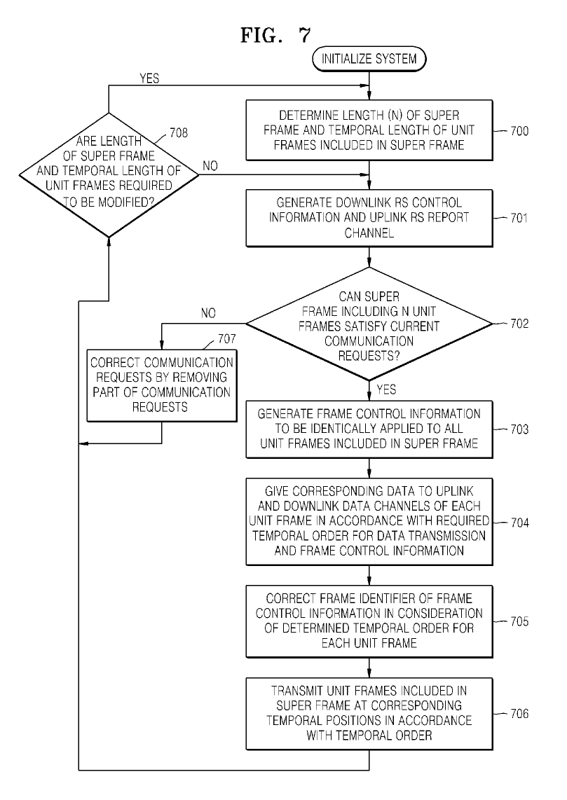

FIG. 7 is a detailed flowchart of a method of using frames in an MMR network, the method including the method of FIG. 6, according to an embodiment of the present invention.

Referring to FIG. 7, the length of a super frame to be generated is determined at a point of time when generation of the super frame commences in accordance with topology and communication requests of the MMR network in operation 700. The length of the super frame is the number of unit frames to be included in the super frame. The length of the super frame may be determined by setting a predetermined value when a system is initialized and using the value as the length of the super frame regardless of variations of the topology of the MMR network, or by using a variety of calculating methods in accordance with a usage policy of the MMR network. If the length of the super frame is determined to be excessively long, data transmission may be delayed and data output speed of the MMR network may decrease.

As an example of the calculating methods, the length of the super frame can be determined as a larger number selected from the maximum number of hops for relay stations (MHR) obtained by adding one to the maximum number among the numbers of hops of a plurality of relay stations connected to a base station at a point of time when the super frame begins to be generated, and the maximum number of hops for mobile stations (MHM) obtained by subtracting one from the result of multiplying by two the maximum number among the numbers of hops of a plurality of mobile stations having uplink data to be allocated in the super frame.

For example, if the topology and the communication requests are assumed to be as illustrated in FIG. 5, the numbers of hops of relay stations RS11, RS12 and RS21 are one, one, and two, respectively. Thus, the MHR is three. The numbers of hops of mobile stations MS11, MS12, and MS22 having uplink data are one, one, and two, respectively. The maximum number of hops is two and the MHM is three (2×2−1=3). Therefore, the larger value selected from the MHR and MHM is three. Thus, the length of the super frame may be determined as three.

The length of all unit frames included in the super frame has to be the same.

The base station generates relay station control information to be transmitted to a relay station in order to control some operations of the relay station in operation 701. The relay station control information may be transmitted through a downlink data channel or be included in frame control information. The relay station control information includes the length of the super frame, a frame number of an initial unit frame of the super frame, and information on a final uni frame of the super frame. A relay station report channel is generated to be used for reporting uplink data from the relay station to the base station when particularly required by the relay station or when the base station needs the data from the relay station. The relay station report channel may be temporarily or regularly allocated as required.

It is checked whether the super frame determined in operation 701 can satisfy the entire communication requests in operation 702. If not, in operation 707, a part of the communication requests is removed by a predetermined rule and the base station recalculates the length of the super frame. The removed part of the communication requests are transmitted in a subsequent super frame. If necessary, in operation 708, the length of the super frame and the temporal length of the unit frames may be modified. The number or temporal length of the unit frames included in the super frame may be fixed as a constant.

The base station generates frame control information to be identically applied to all unit frames included in the super frame in operation 703. The frame control information is allocated in consideration of the topology and the communication requests of the MMR network, and the capacities of data channels of the unit frames. All unit frames included in the super frame have the same frame control information.

Data for uplink and downlink data channels of each unit frame are given in accordance with required temporal order of the unit frames and the frame control information in operation 704.

However, if the frame control information generated in operation 703 includes frame identifier information for identifying the unit frames, the frame identifier information may be corrected to be different for each unit frame in operation 705.

Lastly, the unit frames transmit the frame control information and data of the downlink data channels and receive data of the uplink data channels at corresponding temporal positions in accordance with the temporal order in operation 706.

After data transmission of the super frame is completed, if the length of a subsequent super frame needs to be calculated in operation 708, the method returns to operation 700. If not, the method skips operation 700, and proceeds to subsequent operations.

Operations 700 through 708 may be preformed in different order as long as the same result is induced.

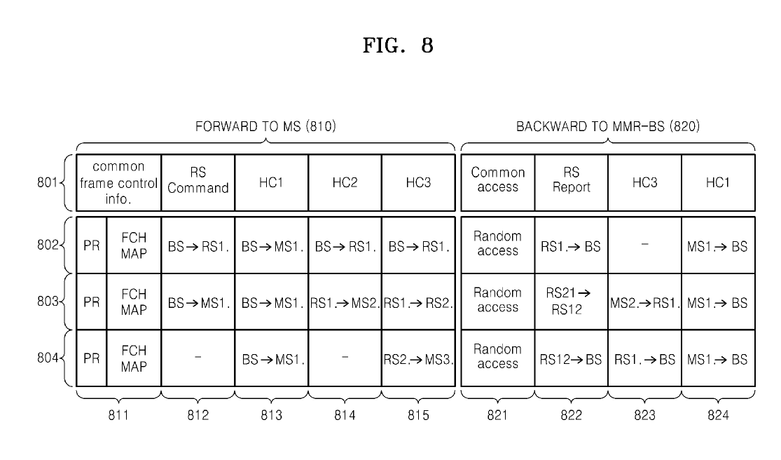

FIG. 8 is a table for illustrating the result of allocating hop channels for a super frame by using the method of FIG. 7 if topology and communication requests of a MMR network are assumed to be as illustrated in FIG. 5, according to an embodiment of the present invention. FIG. 8 will be described in conjunction with FIG. 5.

Referring to FIG. 8, a row 801 indicates channels included in subsequent unit frames 802 through 804 composing the super frame and columns 811 through 815 and 821 through 824 indicate temporal orders.

An initial unit frame 802 is firstly issued, then a subsequent unit frame 803 is issued, and a final unit frame 804 is lastly issued. An arrow represents the direction of data transmission.

A front part of a unit frame 810 includes downlink data channels to mobile stations, such as a frame control information channel 811, a relay station control information channel 812 including relay station control information to be transmitted from a base station to a relay station, a one-hop downlink data channel 813 used for data transmission to mobile stations having a one-hop distance from the base station, a two-hop downlink data channel 814 used for data transmission to mobile stations having a two-hop distance from the base station, and a three-hop downlink data channel 815 used for data transmission to mobile stations having a three-hop distance from the base station.

A back part of a unit frame 820 includes uplink data channels from the mobile stations to the base station, such as a random access channel 821 to be randomly accessed by a mobile station, a relay station report channel 822 for reporting data from the relay station to the base station, a three-hop uplink data channel 823 used for data transmission from the mobile station MS22 having a two-hop distance to the base station, and a one-hop uplink data channel 824 used for data transmission from the mobile stations MS11 and MS12 having a one-hop distance to the base station.

The allocation of the hop channels as illustrated in FIG. 8 is an example of allocation. The hop channels may also be allocated in different ways.

With reference to the above description, each hop channel will now be described in detail.

According to the current embodiment, the frame control information channel 811 includes frame control information composed of a preamble (PR), a frame control header (FCH), and an MAP (channel allocation information of a unit frame). The frame control information channel 811 includes positions and instructions of the uplink and downlink data channels. Except for frame identifier information, the same frame control information is used for the three subsequent unit frames 802, 803, and 804. The relay station control information channel 812 for each unit frame has the same position and size according to the frame control information of the frame control information channels 811. However, data of the relay station control information channel 812 may be different for each unit frame. The one-hop downlink data channel 813 has the same position and size for each unit frame according to the frame control information of the frame control information channel 811. However, data of the one-hop downlink data channel 813 may be different for each unit frame.

The two-hop downlink data channel 814 is used to transmit downlink data to the mobile stations MS21 and MS23. The two-hop downlink data channel 814 for each unit frame has the same data. However, a certain unit frame, for example, the unit frame 804 may not use the two-hop downlink data channel 814. The two-hop downlink data channel 814 of the unit frame 802 transmits the data from the base station to a one-hop relay station and the two-hop downlink data channel 814 of the unit frame 803 transmits the data from the one-hop relay station to the mobile stations MS21, MS22, and MS23.

The three-hop downlink data channel 815 for each unit frame has the same data. The three-hop downlink data channel 815 of the unit frame 802 transmits the data from the base station to the relay station RS12, the three-hop downlink data channel 815 of the unit frame 803 transmits the data from the relay station RS12 to the relay station RS21, and the three-hop downlink data channel 815 of the unit frame 804 transmits the data from the relay station RS21 to the mobile station MS31.

Random access signals received by relay stations may be relayed to the base station through the random access channel 821 in a subsequent unit frame. Alternatively, mobile station access information received through the random access channel 821 may be relayed to the based station through the relay station report channel 822.

The three-hop uplink data channel 823 is used for data transmission from the mobile station MS22 having a two-hop distance to the base station. As the relay station RS12 receives the unit frame 802, the relay station RS12 only recognizes the three-hop uplink data channel 823. And data transmission through the three-hop uplink data channel does not occur. The relay station RS12 transmits the unit frame 802 to a mobile station by using the unit frame 803 and the mobile station recognizes uplink data channels allocated to the mobile station. An the mobile station transmits data through the three-hop uplink data channel 823 of the unit frame 803. Thereafter, the relay station RS12 receives the data and then transmits the data to the base station through the three-hop uplink data channel 823 of the unit frame 804.

The one-hop uplink data channel 824 may have different data for each unit frame. Assuming that a data transmission capacity of a one-hop uplink data channel is 100, data occupying a capacity of 300 may be transmitted to the base station.

In the downlink channel period 810, order and arrangement of the hop channels except for the frame control information channel 811 may vary and the size of each hop channel may also vary in accordance with an MMR system.

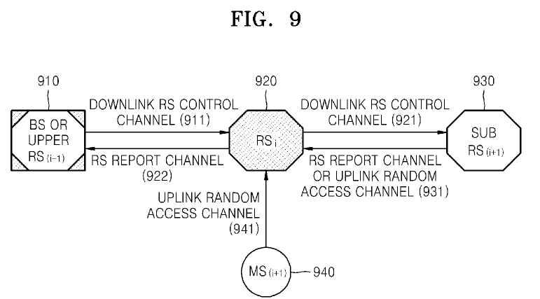

FIG. 9 is a diagram for illustrating communication channels required for managing routing information that has to be maintained for processing unit frames by a relay station, according to an embodiment of the present invention.

In an MMR system, the relay station has to maintain the routing information for correctly relaying signals. The routing information has to include link addresses (or identifiers) of mobile stations and sub relay stations passing through the relay station. The relay station receives a unit frame. And, if a link address (or an identifier) of a destination which is included in the unit frame is included in the link addresses (or identifiers) included in the routing information managed and maintained by the relay station, the relay station relays data of the unit frame. If not, the relay station does not relay the data of the unit frame so as not to cause unnecessary interference.

The above operation will now be described in detail with reference to a relay station RSi 920. Here, i (i=1, 2, 3, . . . ) represents the number of hops from a base station. The relay station RSi 920 performs data communication with a base station BS or upper relay station RS(i−1). BS or RS(i−1) is indicated by a reference numeral 910. The relay station RSi 920 receives a downlink frame signal from the base station or upper relay station BS or RS(i−1) 910 and transmits an uplink frame signal to the base station or upper relay station BS or RS(i−1) 910. The relay station RSi 920 is directly connected to a mobile station MS(i+1) 940 and functions as a serving relay station of the mobile station MS(i+1) 940. A sub relay station RS(i+1) 930 and the mobile station MS(i+1) 940 are connected to the base station or upper relay station BS or RS(i−1) 910 through the relay station RSi 920.

The routing information may be modified by secondarily using uplink and downlink data channels. However, basically, when an initial network access request of the mobile station MS(i+1) 940 is successfully received through an uplink random access channel 941, or when data is received from the sub relay station RS(i+1) 930 through a relay station report channel or an uplink random access channel 931, the routing information may be modified by checking the link addresses (or the identifiers) included in the relay station report channel or an uplink random access channel 931 and the uplink random access channel 941, and adding the link address (or the identifiers) to the routing information. The modified routing information is reported to the base station or upper relay station BS or RS(i−1) 910 through a relay station report channel 922.

When the relay station RSi 920 determines not to manage a link address (or an identifier) which is included in the routing information by checking data received from the base station or upper relay station BS or RS(i−1) 910 through a downlink relay station control channel 911, the relay station RSi 920 may remove the link address (or the identifier) from the routing information. The data received through the downlink relay station control channel 911 is transmitted to the sub relay station RS(i+1) 930 through a downlink relay station control channel 921 by using a subsequent unit frame.

The link addresses are identifier information of the mobile station MS(i+1) 940 and the sub relay station RS(i+1) 930 connected to the relay station RSi 920.

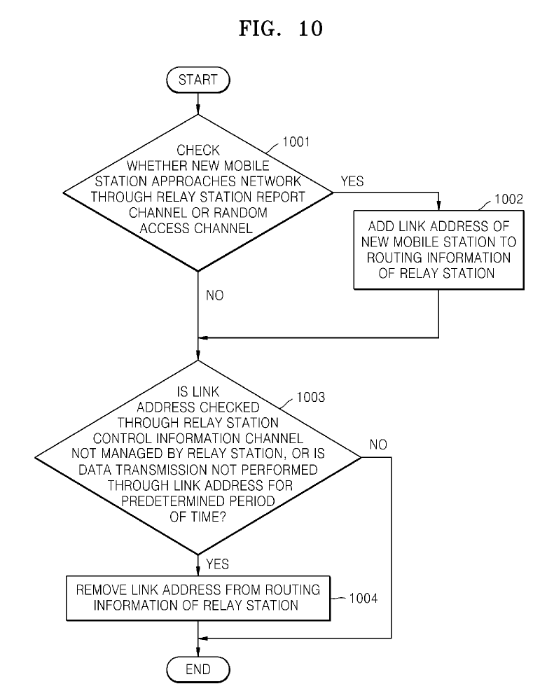

FIG. 10 is a flowchart of a method of managing routing information by a relay station, according to an embodiment of the present invention.

Referring to FIG. 10, if the relay station recognizes that a new mobile station approaches the mobile multi-hop relay network through a relay station report channel, that is, an uplink report channel to the base station or a random access channel for transmitting information of mobile stations to the base station in operation 1001, the relay station adds a link address of the new mobile station to the routing information of the relay station in operation 1002. If the link address checked through the relay station control information channel from the base station is not managed by the relay station, or, if uplink or downlink data transmission is not performed for a predetermined period of time through a link address managed by the relay station in operation 1003, the relay station removes the link address checked or the link address managed by the relay station from the routing information of the relay station in operation 1004.

The relay station notifies the approaching of the new mobile station to the base station through the relay station report channel 922 after adding the link address of the new mobile station to the routing information of the relay station in operation 1002, and the relay station notifies the removing of the link address to sub relay stations through the relay station control information channel after removing the link address from the routing information of the relay station in operation 1004.

In more detail, when data of a mobile station or a sub relay station is successfully received through an uplink random access channel in process of the initial network entering, a link address (or a channel identifier) included in the data is added to the routing information in operation 1002. When the relay station receives information of a change of topology from the base station through the relay station control channel 911, a corresponding link address (or a channel identifier) is removed from the routing information, or when uplink or downlink data transmission is not performed through a link address (or a channel identifier) managed by the relay station for a predetermined period of time, the link address (or the channel identifier) is removed from the routing information in operation 1004.

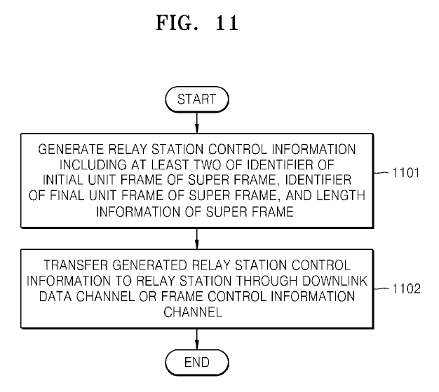

FIG. 11 is a flowchart of a method of generating and transferring relay station control information by a base station, according to an embodiment of the present invention.

Referring to FIG. 11, the base station generates the relay station control information including at least two of: frame identifier information (start information) of an initial unit frame of a super frame which is to be used as a communication frame and is formed by binding one or more sequential unit frames on the time axis which are basic units for data communication; frame identifier information (end information) of a final unit frame of the super frame; and length information of the super frame in operation 1101. The base station transfers the relay station control information to a target relay station by allocating the relay station control information to a downlink data channel of a unit frame or including the relay station control information to frame control information of the unit frame in operation 1102.

The target relay station receives and analyzes the relay station control information and, if a current unit frame is the final unit frame of the super frame, the target relay station does not generate a subsequent unit frame, that is, the target relay station does not transmit data of a subsequent unit frame. When the base station allocates the relay station control information to the downlink data channel, a multicasting channel for entire relay stations is used.

The relay station control information is a relay command message. Each of the frame identifier information of the initial unit frame of the super frame, and the frame identifier information of the final unit frame of the super frame, which are included in the relay command message, has to be at least 8-bit. A command body may include requirements for later controlling the relay station. The command body may include routing information on a relay station or operations of the relay station.

The relay station may report a relay report message, which corresponds to the relay command message, through an allocated uplink data channel and a corresponding report body includes requirements for later data communication. The report body may include ranging information of a mobile station, another neighboring mobile station, or another neighboring relay station, etc.

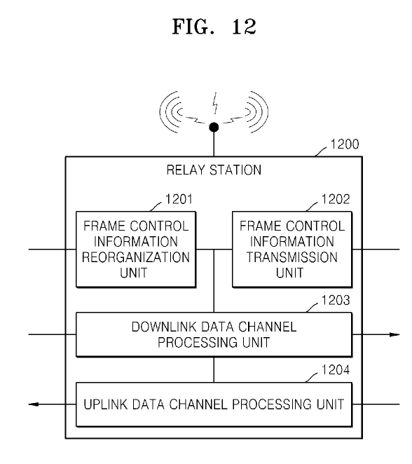

FIG. 12 is a block diagram of a relay station 1200 for processing unit frames, according to an embodiment of the present invention.

Referring to FIG. 12, the relay station 1200 includes a frame control information reorganization unit 1201 recognizing frame control information of a received unit frame and reorganizing the frame control information of the received unit frame into frame control information of a predetermined or predicted subsequent unit frame in order to allow a base station and neighboring relay stations to transmit the same frame control information through the subsequent unit frame, a frame control information transmission unit 1202 transmitting the reorganized frame control information through the subsequent unit frame to the neighboring relay stations, a downlink data channel processing unit 1203 transmitting data through the subsequent unit frame if the data exists in a downlink data channel of the received unit frame which passes through the relay station 1200, an uplink data channel processing unit 1204 transmitting data through the subsequent unit frame if the data exists in an uplink data channel or a random access channel of the received unit frame which passes through the relay station 1200.

In particular, the frame control information reorganization unit 1201 changes frame identifier information of the received unit frame into frame identifier information of the subsequent unit frame after recognizing the frame control information of the received unit frame and reorganizes the frame control information of the received unit frame based on the result of the change. Here, if the frame identifier information is a frame number, the frame control information (or the frame) may be corrected and reorganized by using the frame number added by one. It is assumed that the frame control information transmission unit 1202 transmits the reorganized frame control information only if the increased frame number is between the frame number of an initial unit frame and the frame number of a final unit frame which are checked by relay station control information (or a relay command message) (for example, calculated by using a module 2⁸), and uplink data transmission through the subsequent unit frame is not expected. In particular, the above assumption has to be satisfied for downlink data transmission. In a case of uplink data transmission, the relay station 1200 transmits uplink data through the subsequent unit frame whenever the relay station 1200 receives the uplink data through the current frame.

The frame control information transmission unit 1202 transmits the reorganized frame control information at a predetermined point of time of the subsequent unit frame, the downlink data channel processing unit 1203 transmits the data (downlink data) of the received unit frame through the same downlink data channel of the subsequent unit frame as the downlink data channel of the received unit frame, and the uplink data channel processing unit 1204 transmits the data (uplink data) of the received unit frame through the same uplink data channel of the subsequent unit frame as the uplink data channel of the received unit frame.

The transmitting of the reorganized frame control information by the frame control information transmission unit 1202 is performed if the frame control information of the current unit frame is a signal received from an upper relay station having the number of hops one less than the number of hops of the relay station 1200 or received from a base station having a one-hop distance to the relay station 1200, and the current unit frame is not a final unit frame of a super frame. A condition for the transmitting of the reorganized frame control information by the frame control information transmission unit 1202 is determined by the base station and the base station transmits the determined condition to the relay station 1200 through a multicasting channel for all relay stations.

If the relay station 1200 transmits the frame control information through a current unit frame or if the current unit frame is a final unit frame of a super frame, the relay station 1200 is converted to a reception mode for the subsequent unit frame in order to receive new frame control information.

If ranging information is received from mobile stations, the relay station 1200 gathers pieces of the ranging information so as to transmit the ranging information as a relay report message.

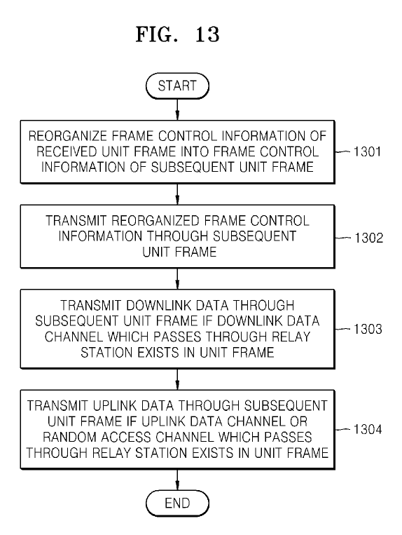

FIG. 13 is a flowchart of a method of processing unit frames and transmitting frame control information and data by a relay station, according to an embodiment of the present invention.

In an MMR network, a base station adaptively uses a super frame in accordance with topology of the MMR network, frame control information forming headers of unit frames, which are included in the super frame, is generated to be the same for each unit frame, and frame identifier information is corrected to be the same so that the base station and relay stations, from which the frame control information for a certain unit frame is transmitted, may transmit the same frame control information. Thus, interference between the base station and the relay stations is fundamentally prevented from occurring and MMR cells can be flexibly designed.

Referring to FIG. 13, the relay station recognizes frame control information of a received unit frame and reorganizes the frame control information of the received unit frame into frame control information of a predetermined or predicted subsequent unit frame in order to enable a base station and neighboring relay stations to transmit the same frame control information through the subsequent unit frame in operation 1301. The relay station transmits the reorganized frame control information through the subsequent unit frame to the neighboring relay stations in operation 1302.

If the data exists in a downlink data channel of the received unit frame which passes through the relay station, the relay station transmits the data through the subsequent unit frame in operation 1303. If the data exists in an uplink data channel or a random access channel of the received unit frame which passes through the relay station, the relay station transmits the data through the subsequent unit frame in operation 1304.

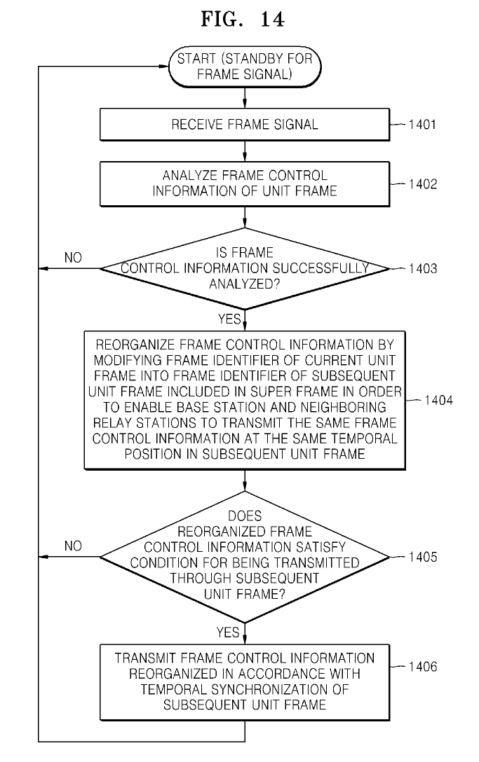

FIG. 14 is a detailed flowchart of the method of FIG. 13, according to an embodiment of the present invention.

Referring to FIG. 14, a relay station begins to receive a frame signal of a unit frame in operation 1401, and analyzes frame control information of the unit frame which is disposed at a front part of the unit frame in operation 1402. If the frame control information is successfully analyzed in operation 1403, the relay station recognizes the frame control information including frame identifier information of the unit frame into frame control information of a predetermined or predicted subsequent unit frame in order to enable a base station and neighboring relay stations to transmit the same frame control information through the subsequent unit frame in operation 1404.

The relay station has to determine whether to transmit the reorganized frame control information through the subsequent unit frame in operation 1405. Conditions of the determination may vary. If it is confirmed that the subsequent unit frame is out of the temporal range of a current super frame by using relay station control information including the length of the super frame, and information on initial and final unit frames, the frame control information is not transmitted through the subsequent unit frame. Also, if a unit frame transmits data through an uplink channel such as a random access channel or an uplink data channel, the relay station may determine not to transmit the frame control information through the unit frame.

If the frame control information is determined to be transmitted through the subsequent unit frame, the reorganized frame control information is transmitted at a predetermined temporal position of the subsequent unit frame in operation 1406. The predetermined temporal position is included in the reorganized frame control information and the transmitting of the reorganized frame control information is performed if the frame control information of the current unit frame is a signal received from an upper relay station having the number of hops one less than the number of hops of the relay station or received from a base station having a one-hop distance to the relay station, and the current unit frame is not the final unit frame of the super frame. The conditions for the transmitting of the reorganized frame control information is determined by the base station and the reorganized frame control information may be transmitted through a multicasting channel for all relay stations.

If the current unit frame transmits the frame control information or if the current unit frame is the final unit frame of the super frame, the relay station is converted to a reception mode for frame control information of the subsequent unit frame.

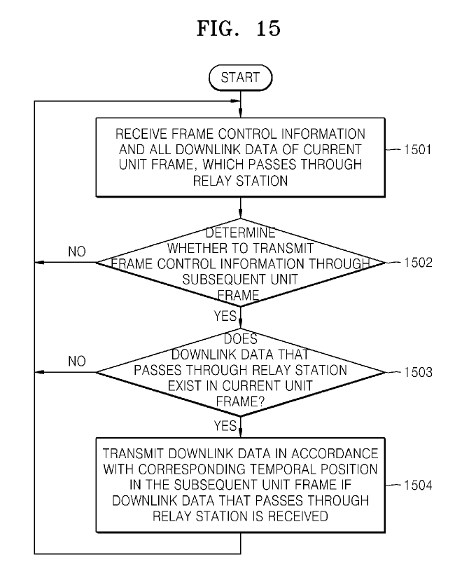

FIG. 15 is a detailed diagram of a method of processing and transmitting downlink data in operation 1303 of FIG. 13, according to an embodiment of the present invention.

Referring to FIG. 15, a relay station has to process the downlink data of a current unit frame which passes through the relay station after the current unit frame including frame control information, and uplink and downlink data channels is received from a base station in operation 1501, and then whether to transmit the frame control information from a subsequent unit frame is determined in operation 1502. The relay station checks whether the frame control information includes a downlink data channel that passes through the relay station in accordance with routing information maintained by the relay station in operation 1503, if one or more downlink data channels exists, the relay station transmits corresponding data in accordance with the timing of the downlink data channel of the subsequent unit frame in operation 1504.

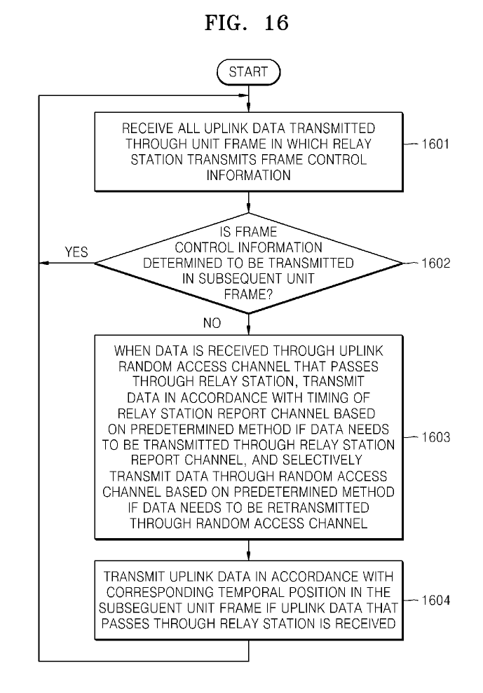

FIG. 16 is a detailed diagram of a method of processing and transmitting uplink data in operation 1304 of FIG. 13, according to an embodiment of the present invention.

Referring to FIG. 16, a relay station receives and stores the uplink data transmitted through all uplink channels of a unit frame in which the relay station transmits frame control information in operation 1601. Here, the uplink channels include a random access channel and an uplink data channel. If the relay station does not transmit the frame control information in subsequent unit frames through downlink channels in operation 1602, the relay station may receive and analyze the frame control information from an upper relay station or a base station and, if control data is received and stored from a previous unit frame through the random access channel of the uplink channels, the relay station may transmit the uplink data through a relay station report channel or the random access channel in operation 1603. If uplink data is received and stored from the previous unit frame, the relay station may transmit the uplink data in accordance with the timing of the uplink data channel of the current unit frame using a link address of the uplink data in operation 1604.

Whether to transmit the frame control information in a subsequent unit frame may be determined by using various methods in operation 1602. For example, if the frame control information is received from the previous unit frame and the relay station is not going to transmit the uplink data through the current unit frame to the upper relay station or the base station, the frame control information may be transmitted through the subsequent unit frame. If the uplink data is received, the relay station receives the frame control information.

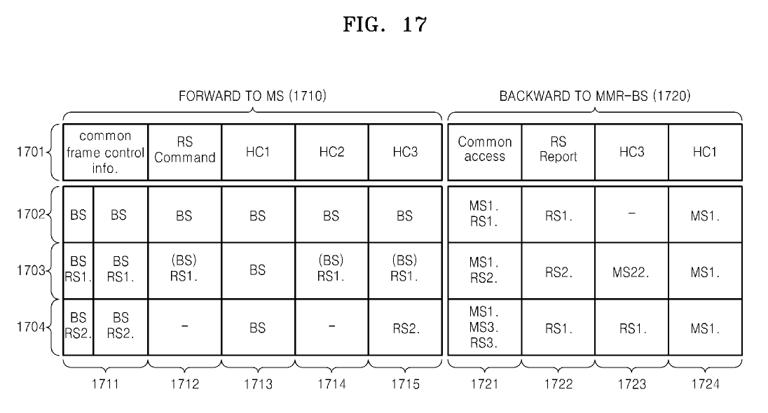

FIG. 17 is a table for illustrating output signals of a base station, relay stations, and mobile stations after processing unit frames and transmitting data in accordance with the method of FIG. 13 from the result of allocating hop channels which is illustrated in FIG. 8 in a MMR network, according to an embodiment of the present invention. FIG. 17 will be described in conjunction with FIG. 5.

Descriptions of the table and reference numerals of FIG. 8 can be referred to for the descriptions of the table and reference numerals of FIG. 17. However, the nodes BS, RS . . . , and MS . . . indicated by the hop channels of each unit frame represent that data is transmitted through corresponding hop channels of corresponding unit frames. A node indicated in parentheses represents that the data may also be transmitted to a corresponding node for multipath diversity.

According to the table, the relay station RS3 may attempt to newly access the MMR network in a region of the relay station RS2 through a random access channel 1721 of an uplink channel period 1720 of a unit frame 1704. The relay stations RS1 and RS2 may also access the MMR network through the random access channel 1721 of unit frames 1702 and 1703, respectively.

The invention can also be embodied as computer readable codes on a computer readable recording medium.

The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to the present invention, in an MMR network, a base station adaptively uses a super frame in accordance with topology of the MMR network, frame control information forming headers of unit frames, which are included in the super frame, is generated to be the same for each unit frame, and frame identifier information is corrected to be the same so that the base station and relay stations, from which the frame control information for a certain unit frame is transmitted, may transmit the same frame control information. Thus, interference between the base station and the relay stations is fundamentally prevented from occurring and MMR cells can be flexibly designed. Also, the MMR network may not be restricted by the maximum number of hops (or the maximum number of relaying) and the frame control information may not be retransmitted in a unit frame, thereby preventing waste of channels of the unit frame.

Furthermore, additional wireless frequency resources are not necessary for relaying a signal and overheads caused by restriction of temporal positions of uplink and downlink data channels in accordance with topology of an MMR system may be reduced While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of generating and transmitting a super frame to be used as a communication frame by a base station in a mobile multi-hop relay network, the method comprising:
(a) determining the number and temporal length of unit frames which are basic units for data communication and are to be included in the super frame formed by binding one or more sequential unit frames on a time axis;
(b) allocating channel periods for transmitting data having a communication request to uplink and downlink data channels of each unit frame based on topology and communication requests of the mobile multi-hop relay network;
(c) generating frame control information which includes common reference information for recognizing and analyzing the unit frames, to be the same for each unit frame and allocating each piece of the frame control information to each unit frame included in the super frame; and
(d) transmitting each piece of the frame control information for each unit frame included in the super frame together with downlink data to be transmitted, based on the allocated channel periods.

2. The method of claim 1, wherein, if the super frame cannot satisfy the communication requests of the mobile multi-hop relay network by using the number of unit frames which is determined in (a), the communication requests are corrected so as to remove a part of the communication requests.

3. The method of claim 1, wherein (a) comprises:
determining the number and temporal lengths of the unit frames to be included in the super frame; and
generating a relay station control information channel for processing the unit frames to be included in the super frame in a relay station and/or a relay station report channel for reporting data from the relay station to the base station.

4. The method of claim 1, wherein, in (c), frame identifier information of each piece of frame control information for each unit frame which identifies each unit frame is generated not to be the same as the frame identifier information of a piece of the frame control information of another unit frame, and, in (d), each unit frame is transmitted after the frame identifier information of each unit frame is corrected and applied in accordance with temporal order of the unit frames to be transmitted.

5. The method of claim 1, wherein, in (a), the number of unit frames to be included in the super frame is determined as a larger value selected from a value obtained by adding one to the maximum number among the numbers of hops of a plurality of relay stations connected to the base station at a point of time when generation of the super frame commences, and a value obtained by subtracting one from the result of multiplying by two the maximum number among the numbers of hops of a plurality of mobile stations having uplink data to be allocated in the super frame, and
wherein the numbers of hops of the relay stations are the minimum numbers of wireless links from the relay stations to the base station.

6. The method of claim 1, wherein, in (a), the number or temporal length of unit frames to be included in the super frame is previously determined and fixed as one constant.

7. The method of claim 1, wherein (b) comprises:
checking the number of hops of each mobile station to the base station, a data transmission request from each mobile station to the base station, and a data transmission request from the base station to each mobile station;
determining hop channels for the data transmission requests in accordance with the number of hops based on the topology of the mobile multi-hop relay network; and
allocating the determined hop channels to uplink and downlink data channel periods of each unit frame included in the super frame.

8. A method of managing routing information of a relay station for relaying data between a base station and a mobile station in a mobile multi-hop relay network, the method comprising:
(a) if the relay station recognizes that a new mobile station approaches the mobile multi-hop relay network through a relay station report channel which is an uplink report channel to the base station or a random access channel for transmitting information of mobile stations to the base station, adding a link address of the new mobile station to the routing information of the relay station; and
(b) if the relay station determines not to manage a link address checked through a relay station control information channel from the base station, or, if uplink or downlink data transmission is not performed for a predetermined period of time through a link address managed by the relay station, removing the link address from the routing information of the relay station.

9. The method of claim 8, wherein, in (a), the relay station notifies the approaching of the new mobile station to the base station through the relay station report channel after adding the link address of the new mobile station to the routing information of the relay station, and, in (b), the relay station notifies the removing of the link address to sub relay stations through the relay station control information channel after removing the link address from the routing information of the relay station.

10. The method of claim 8, wherein the link address is identifier information of a mobile station connected to the relay station or identifier information of another sub relay station.

11. A method of generating and transferring relay station control information for controlling operations of a relay station by a base station in a mobile multi-hop relay network, the method comprising:
(a) generating the relay station control information including at least two of frame identifier information of an initial unit frame of a super frame which is to be used as a communication frame and is formed by binding one or more sequential unit frames on a time axis which are basic units for data communication, frame identifier information of a final unit frame of the super frame, and length information of the super frame; and
(b) transferring the relay station control information to a target relay station by allocating the relay station control information to a downlink data channel of a unit frame or including the relay station control information to frame control information of the unit frame.

12. The method of claim 11, wherein (b) comprises transferring the relay station control information to the target relay station by allocating the relay station control information to a multicasting channel for all target relay stations.

13. The method of claim 11, wherein the target relay station receives and analyzes the relay station control information and, if a current unit frame is the final unit frame of the super frame, the target relay station does not transmit data from a subsequent unit frame.

14. A method of processing unit frames by a relay station in a mobile multi-hop relay network, the method comprising:
(a) recognizing frame control information of a received unit frame and reorganizing the frame control information of the received unit frame into frame control information of a predetermined or predicted subsequent unit frame in order to enable a base station and neighboring relay stations to transmit the same frame control information through the subsequent unit frame;
(b) transmitting the reorganized frame control information through the subsequent unit frame to the neighboring relay stations;
(c) transmitting data through the subsequent unit frame if the data exists in a downlink data channel of the received unit frame which passes through the relay station; and
(d) transmitting data through the subsequent unit frame if the data exists in an uplink data channel or a random access channel of the received unit frame which passes through the relay station.

15. The method of claim 14, wherein (a) comprises:
changing frame identifier information of the received unit frame into frame identifier information of the subsequent unit frame after recognizing the frame control information of the received unit frame; and
reorganizing the frame control information of the received unit frame based on the result of the change.

16. The method of claim 14, wherein (b) comprises transmitting the reorganized frame control information at a predetermined point of time of the subsequent unit frame which is based on the reorganized frame control information.

17. The method of claim 14, wherein (c) comprises transmitting the data of the received unit frame through the same downlink data channel of the subsequent unit frame as the downlink data channel of the received unit frame, and
wherein (d) comprises transmitting the data of the received unit frame through the same uplink data channel of the subsequent unit frame as the uplink data channel of the received unit frame.

18. The method of claim 14, wherein (b) is performed if the frame control information of the current unit frame is a signal received from an upper relay station having the number of hops one less than the number of hops of the relay station or received from a base station having a one-hop distance to the relay station, and the current unit frame is not a final unit frame of a super frame.

19. The method of claim 14, wherein a condition for the transmitting of the reorganized frame control information in (b) is determined by the base station and the base station transmits the determined condition to the relay station through a multicasting channel for entire relay stations.

20. The method of claim 14, wherein, if the relay station transmits the frame control information through a current unit frame or if the current unit frame is a final unit frame of a super frame, the relay station is converted to a reception mode for the subsequent unit frame in order to receive new frame control information.
